(19) United States
(12) Patent Application Publication
(10) Pub. No.: US 2014/0066190 A1
(43) Pub. Date: Mar. 6, 2014

(54) Gambling Game That Provides High Winning Chance And Maximum Flexibility To Players

(71) Applicant: Eli Shnoer Golan, Mitspe Adi (IL)

(72) Inventor: Eli Shnoer Golan, Mitspe Adi (IL)

(21) Appl. No.: 13/746,337

(22) Filed: Jan. 22, 2013

Related U.S. Application Data
(60) Provisional application No. 61/696,815, filed on Sep. 5, 2012.

(51) Int. Cl. G07F 17/32

(52) U.S. Cl. CPC G07F 17/3244
USPC 463/28; 463/26

(57) ABSTRACT

A gambling game that contains different rooms, with different amount of players. and with different amount of money, according to the room, that each player can gamble on, will provide a platform for withdraw that if dividing the money of all player to 100 winners, each player will have very high chance to win, with regards to money that he will invest, and the relative number of winner in each withdraw.

### TECHNICAL FIELD

The present invention relates to a gambling game with a unique concept of different rooms, with different numbers of player, that can gamble in different amount of money.

The invention will represent different types of games, that all built and have the same concept and infrastructure, and will all give the player an equal and well fair chance to win a big amount of money, while taking relatively low risk, when entering a game room, and playing, or participating in a game.

In addition, the invention related to a. method of cash flow transaction between the players and the game management, and when playing the game the player will pay the minimum entering amount that allows him to play the current game, according to the type of room and game he choose to play, and the money will be transfer from its account directly to the management of the game, and when the lottery will take place, the winning numbers will receive the winning money also directly into their account.

The invention will also represent different rooms. and types of games available, and the amounts, or function, from which the winning amount is calculated from. The player will be able to choose with how many players they wish to play, and what amount they wish to win, according to the money that they will want to gamble with. As an example: a player that play with X amount of money can win in one room 1000X, while if he plays in different room he can win 1000000X, all depend on the type of room and type of game he wishes to play.

### BACKGROUND ART

Heretofore, the invention relates to different rooms, all have a fixed amount of player that will have to register before the withdraw will begin. When the room is full the withdraw will take place, where each player will have its own number. In each game, and each withdraw the number of winners will always be 100 players. In addition to each room there is fixed amount of money that the player can gamble on, for each number, or chance, to win. As an example: a room with 40$ minimum gambling amount, that contains 5M player, the amount that each player will win. from the 100 winners in this specific game, is $2M. Another example is a game with the same amount of gambling money of $40, but with 5000 players. Each winner, from the 100 winners, will receive $2000.

the current game, and rooms, will not start the gambling until all the room is full, and only then the gabling will start, choosing 100 numbers, or player, to win the specific game.

The current situation is that people invest hundreds of dollars and their chance to win is very low, while the represented invention related to a relatively fair chance, with relatively low amount of money, that can gain the winner huge amount of winning money, with relatively high chance to win. In addition, if a player wishes to open a new game, as the specific game that he wishes to play is without gamblers, he can open a new game, or enter to a new room, that has the term he wishes to play according to, other player will than join the room, and when the room with be full the game will start, choosing 100 people to win the specific game, and receiving immediately the winning money into their account.

### SUMMARY OF INVENTION

An object of the present invention is different gambling room, each with a minimum amount of money that a single player can play with, and each with a pre-determined number of player. In addition, the gambling, or lottery, will begin when the room is full with registered player, and in each game there will be 100 winners, that will divide the plot between them.

Another object of the present invention is that each player, when registered to specific room, and game, will transfer the money to the specific game immediately when registered. In addition the winning money for the 100 players that won the specific game, will also be transferred immediately to their account.

Yet, another object of the present invention is a. function from which each room will be built from—with regards to the minimum money that a single player need to pay, and with regards to the winning price of the specific room, and specific game. The formula can be describes as: X—will be the minimum amount of money that a single player can play, in this specific room, and in the specific game. Y will be the number of player in the specific game that only when the number Y will be reached to, which mean Y people will be registered to the specific game. The profit of the 100 winners will be according to the formula of: (X*Y/100). As an example, if a player is entered into a room that the minimum amount of money to play with is X=$160. and the number of Players is Y=1.25M. Than the winning price of this specific room is $2M to each one of the 100 winners.

Another object of the present invention is that on each transaction of the game, and players, when paying the money to enter the game, or when receiving the Winning money, the game management, or organizer's of the game will receive some sort of fee, or payment.

The author would like to indicate that because a the represented solution has many options, that can he implement separately, and in parallel, the current invention is protect the game method regardless the minimum amount of money that each player need to pay, and with regardless to the minimum number of players in each game. and as long as each game 100 people will receive the money price in a formula that relatively close in result to: WY/100).

### BRIEF DESCRIPTION OF DRAWINGS

FIG. 1 represents different rooms—Room A, Room B, Room C & Room D. In each room there are example number that also describe few rooms—1-7 in room A, 8-14 in Room B, 15-22 in Room C and 23-30 in Room D. each one of rooms and each one of the examples number that appear in each room represents room with different gambling game and different amount of money that the player will be able to gamble on. In addition, in each one of the rooms, or examples room, the number of player is changing, and therefore allowing the player to decide how much money he wishes to gamble on, and how much money he wishes to earn if he will be one of the 100 people that will win the specific draw.

FIG. 1 also represents examples of the games. As example: if a player is wishes to play on $20 and he whish to have the change to be a winner from a batch of 10000 people. than if he will win he will earn the amount of $2000. The specific player in the example need than to enter Room D. and to sub room number 23. The minimum amount to gamble in this specific room is $20, and the game will start when the room will have 10000 registered players. The draw will than take place and the chosen 100 people will earn, each. amount of $2000.

another examples that being described in FIG. 1 is in Room B, sub room 8. Where the player will gamble on $40, and will have the chance of be 1 of the 100 people that will be chosen from 5M people who will win in the end of the draw in $2M each. In addition, if a player wishes to increase his chance of winning he can than buy another ticket in an addition amount of $40, and than he will have the chance of 2 of 100 people that can win the price, from a hatch of 5M people.

FIG. 1 also describes situation where it is not possible to open a room as the number of players with regards to the number of money each player will play on is not applicable. As described in room number 14 and room number 30. The amount of $2560 with regards to the number of players will not provide the winner with $2M, as the multiplication of the money, $2560. and the people, which should be 156K divided by 2. will not give a round number of $2M. and therefore the room will not be exist in the rooms list.

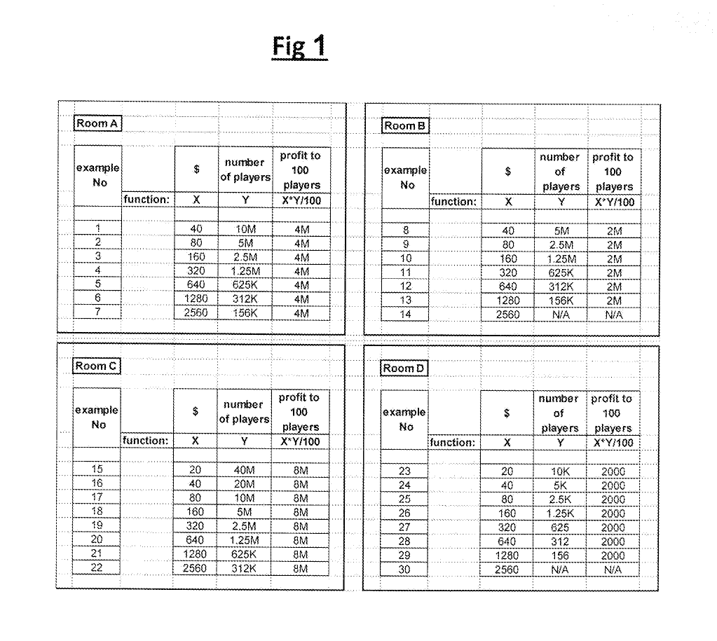

### GENERAL DESCRIPTION

One who read this description, and the current application, must not consider the author's way of expression as fact and must consider the description as novel concept for creating few rooms, or playing yards, that vary according to the money each player wishes to gamble on, and in addition vary in the number of player in each game. Accordingly the amount of wining that each 100 people will take in each draw will vary. In addition, if a player is whishes to play in a room that is empty he can than open a new game and wait until it will be full so the withdraw will take place.

With respect to the above description then, it is to be realized that the optimum dimensional relationships for the parts of the invention, to include variations in size. materials, shape, form, function and manner of operation, assembly and use, are deemed readily apparent and obvious to one skilled in the art, and all equivalent relationships to those illustrated in the drawings and described in the specifications are intended to be encompassed by the present invention. Therefore the foregoing is to be considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A gambling game that contains different rooms, with different amount of players. and with different amount of money, according to the room, that each player can gamble on, will provide a platform for withdraw that if dividing the money of all player to 100 winners, each player will have very high chance to win, with regards to money that he will invest, and the relative number of winner in each withdraw.

2. With regards to claim 1, each room will perform on the formula that if the amount of money that each ticket provide will be consider as X, and the amount of player in the specific room will be Y, than each 100 player will win in each withdraw in an amount that is X*Y/100.

3. With regards to claim 2, the money that will be transferred by the player will be transfer automatically, and on line, to the management pot, and when the withdraw will take place the winners will receive the money automatically, and on line, to their account.

4. With regards to claim 3, for each transaction, winning, money transfer, or any other transaction being done by the player, the management will receive some sort of payment.
